(19) United States
(12) Patent Application Publication
(10) Pub. No.: US 2023/0032904 A1
(43) Pub. Date: Feb. 2, 2023

(54) MULTILAYER CERAMIC CAPACITOR

(71) Applicant: Murata Manufacturing Co., Ltd., Nagaokakyo-shi (JP)

(72) Inventor: Yusuke YOKOTA, Nagaokakyo-shi (JP)

(21) Appl. No.: 17/859,154

(22) Filed: Jul. 7, 2022

(30) Foreign Application Priority Data
Aug. 2, 2021 (JP) 2021-126503

(51) Int. Cl. H01G 4/30; H01G 4/012; H01G 4/12; H01G 2/14

(52) U.S. Cl. CPC H01G 4/30; H01G 4/012; H01G 4/12; H01G 2/14

(57) ABSTRACT

A multilayer ceramic capacitor includes a multilayer body including internal electrode layers and dielectric layers alternately laminated therein, and external electrodes respectively on end surfaces in a length direction intersecting a lamination direction in the multilayer body, and being electrically connected to the internal electrode layers. The internal electrode layers each include an opposing portion and an extension portion. The opposing portion of one internal electrode layer is opposed to an opposing portion of another internal electrode layer adjacent in the lamination direction. The extension portion extends from the opposing portion and is connected to one of the external electrodes in the length direction. The dielectric layers each have a thickness of about 0.3 μm or more and about 0.5 μm or less, and the internal electrode layers include short-circuit prevention internal electrode layers each including a thin portion with a thickness is no more than about 1/20 the thickness of the dielectric layer in the opposing portion.

### CROSS REFERENCE TO RELATED APPLICATIONS

This application claims the benefit of priority to Japanese Patent Application No. 2021-126503 filed on Aug. 2, 2021. The entire contents of this application are hereby incorporated herein by reference.

### BACKGROUND OF THE INVENTION

### 1. Field of the Invention

The present invention relates to a multilayer ceramic capacitor.

### 2. Description of the Related Art

Multilayer ceramic capacitors have been known that include a multilayer body including a plurality of dielectric layers and a plurality of internal electrode layers stacked therein, and a first external electrode and a second external electrode provided on respective end surfaces of the multilayer body. In such a multilayer ceramic capacitor, the plurality of internal electrode layers include first internal electrode layers connected to the first external electrode and second internal electrode layers connected to the second external electrode, which are alternately laminated.

In such a multilayer ceramic capacitor, when electricity flows through the internal electrode layers, heat is generated due to the resistance, such that the internal electrode layers may be melted, and there is a possibility of the internal electrode layers short-circuiting.

Therefore, Japanese Unexamined Patent Application Publication No. 2016-192472 proposes a multilayer ceramic capacitor including a second capacitor portion. The second capacitor portion includes a third internal electrode layer, a fourth internal electrode layer, and a fifth internal electrode layer above and below the first capacitor portion including the first internal electrode layers and the second internal electrode layers in the lamination direction. Thus, the multilayer ceramic capacitor includes a plurality of capacitance components connected in series between the first external electrode and the second external electrode.

In this conventional multilayer ceramic capacitor, by making the combined capacitance of the second capacitor portion larger than the capacitance of the first capacitor portion, it is difficult for static electricity to flow in the first capacitor portion as compared with the second capacitor portion, thereby making it difficult for short circuiting to occur in the multilayer ceramic capacitor.

### SUMMARY OF THE INVENTION

However, the conventional multilayer ceramic capacitors include such a second capacitor portion in addition to the first capacitor portion. Therefore, the structure is complicated.

Preferred embodiments of the present invention provide multilayer ceramic capacitors that are each less likely to cause a short circuit and include a simple structure.

A multilayer ceramic capacitor according to a preferred embodiment of the present invention includes a multilayer body including a plurality of internal electrode layers and a plurality of dielectric layers alternately laminated therein, and external electrodes respectively provided on both end surfaces in a length direction intersecting a lamination direction in the multilayer body, and being electrically connected to the plurality of internal electrode layers, in which the plurality of internal electrode layers each include an opposing portion and an extension portion, the opposing portion of the internal electrode layer being opposed to an opposing portion of another internal electrode layer adjacent in the lamination direction, the extension portion extending from the opposing portion and being connected to one of the external electrodes in the length direction, the dielectric layers each have a thickness T1 of about 0.3 μm or more and about 0.5 μm or less, and the plurality of internal electrode layers include short-circuit prevention internal electrode layers each including a thin portion having a thickness T21 which is no more than about 1/20 the thickness T1 in each of the opposing portions.

According to preferred embodiments of the present invention, it is possible to provide multilayer ceramic capacitors for which short circuit is less likely to occur, and include a simple structure.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic perspective view of a multilayer ceramic capacitor 1 according to a preferred embodiment of the present invention.

FIG. 2 is a cross-sectional view taken along the line II-II of the multilayer ceramic capacitor 1 of FIG. 1.

FIG. 3 is a cross-sectional view taken along the line III-III of the multilayer ceramic capacitor 1 of FIG. 1.

FIG. 4 is a diagram of a first preferred embodiment of the present invention of a short-circuit prevention internal electrode layer 50.

FIG. 5 is a diagram of a second preferred embodiment of the present invention of the short-circuit prevention internal electrode layer 50.

FIG. 6 is a diagram of a third preferred embodiment of the present invention of the short-circuit prevention internal electrode layer 50.

FIG. 7 is a flowchart of a method of manufacturing the multilayer ceramic capacitor 1 according to a preferred embodiment of the present invention.

FIG. 8 is a table showing test results of advantageous effects of the multilayer ceramic capacitor 1 according to a preferred embodiment of the present invention.

### DETAILED DESCRIPTION OF THE PREFERRED EMBODIMENTS

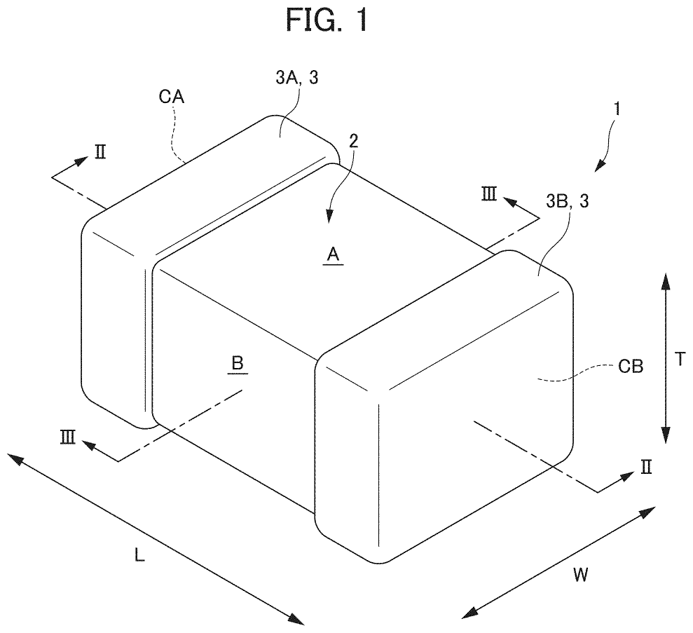

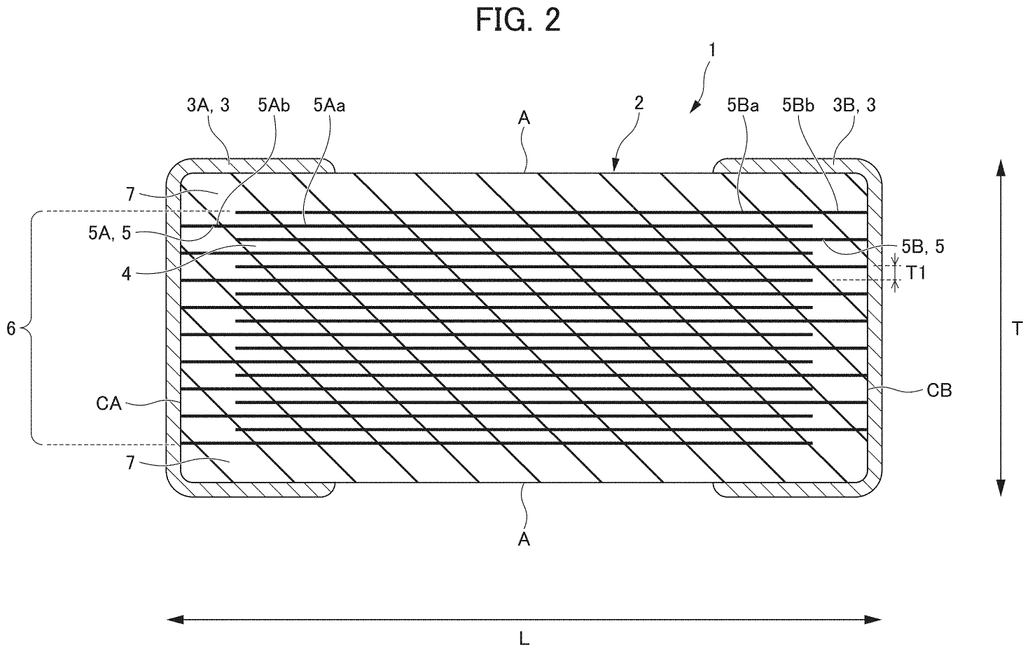

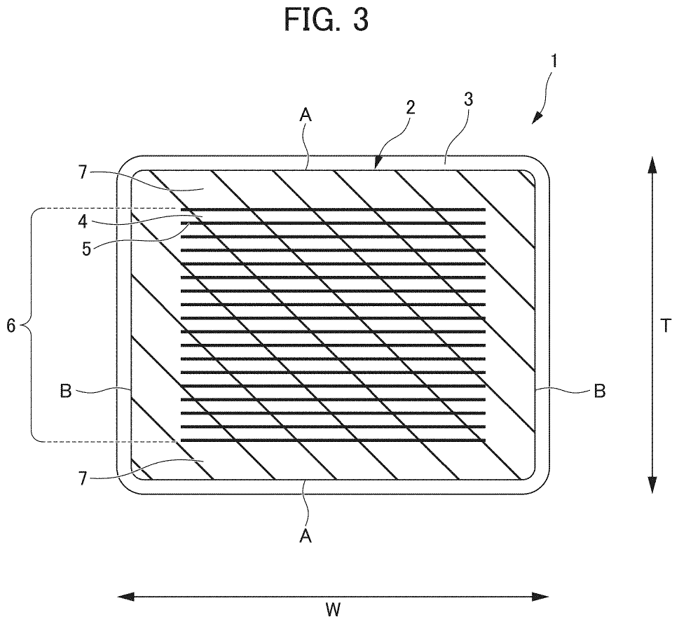

Preferred embodiments of the present invention will be described in detail with reference to the accompanying drawings. Hereinafter, a multilayer ceramic capacitor 1 according to a preferred embodiment of the present invention will be described. FIG. 1 is a schematic perspective view of the multilayer ceramic capacitor 1 according to a preferred embodiment of the present invention. FIG. 2 is a cross-sectional view taken along the line II-II of the multilayer ceramic capacitor 1 of FIG. 1. FIG. 3 is a cross-sectional view taken along the line III-III of the multilayer ceramic capacitor 1 of FIG. 1.

### Multilayer Ceramic Capacitor 1

The multilayer ceramic capacitor 1 may include a rectangular or substantially rectangular parallelepiped shape. The multilayer ceramic capacitor 1 may include a multilayer body 2 and a pair of external electrodes 3 provided at both ends of the multilayer body 2. The multilayer body 2 may include an inner layer portion 6 including a plurality of dielectric layers 4 and a plurality of internal electrode layers 5 stacked therein.

In the following description, terms representing the directions of the multilayer ceramic capacitor 1 are defined as follows. In the multilayer ceramic capacitor 1, a direction in which the pair of external electrodes 3 are provided is defined as a length direction L. A direction in which the dielectric layers 4 and the internal electrode layers 5 are laminated is defined as a lamination (stacking) direction T. A direction intersecting or substantially intersecting both the length direction L and the lamination direction T is defined as a width direction W. In a preferred embodiment of the present invention, the width direction W may be orthogonal or substantially orthogonal to both the length direction L and the lamination direction T.

In the following description, among the six outer peripheral surfaces of the multilayer body 2, a pair of outer peripheral surfaces opposing each other in the lamination direction T is defined as a main surface A, a pair of outer peripheral surfaces opposing each other in the width direction W is defined as a side surface B, and a pair of outer surfaces opposing each other in the length direction L are defined as a first end surface CA and a second end surface CB. When it is not particularly necessary to distinguish between the first end surface CA and the second end surface CB, they are collectively described as the end surface C.

### Multilayer Body 2

The multilayer body 2 may include an inner layer portion 6 and outer layer portions 7 provided on both main surfaces A of the inner layer portion 6.

### Inner Layer Portion 6

The inner layer portion 6 may include the plurality of dielectric layers 4 and the internal electrode layers 5 laminated therein.

### Dielectric Layer 4

The dielectric layers 4 may be each made of a ceramic material. The dielectric layers 4 may each have a thickness T1 of about 0.3 μm or more and about 0.5 μm or less, for example.

### Internal Electrode Layer 5

The internal electrode layers 5 may each include a plurality of first internal electrode layers 5A and a plurality of second internal electrode layers 5B. The first internal electrode layers 5A and the second internal electrode layers 5B may be alternately arranged. When it is not particularly necessary to distinguish between the first internal electrode layers 5A and the second internal electrode layers 5B, they are collectively described as the internal electrode layer 5.

The first internal electrode layer 5A may include a first opposing portion 5Aa opposed to the second internal electrode layer 5B, and a first extension portion 5Ab extending from the first opposing portion 5Aa toward the first end surface CA. The end portion of the first extension portion 5Ab may be exposed at the first end surface CA and electrically connected to a first external electrode 3A described later.

The second internal electrode layer 5B may include a second opposing portion 5Ba opposed to the first internal electrode layer 5A, and a second extension portion 5Bb extending from the second opposing portion 5Ba toward the second end surface CB. The end portion of the second extension portion 5Bb may be electrically connected to a second external electrode 3B described later.

Charges are accumulated in the first opposing portion 5Aa of the first internal electrode layer 5A and the second opposing portion 5Ba of the second internal electrode layer 5B, such that characteristics of the capacitor are generated.

When it is not particularly necessary to distinguish between the first opposing portion 5Aa and the second opposing portion 5Ba, they are collectively described as the opposing portion 5a. In addition, when it is not particularly necessary to distinguish between the first extension portion 5Ab and the second extension portion 5Bb, they are collectively described as the extension portion 5b.

### Outer Layer Portion 7

The outer layer portions 7 may be each made of the same dielectric ceramic material as the dielectric layer 4 of the inner layer portion 6.

### External Electrode 3

The external electrode 3 may include a first external electrode 3A provided on the first end surface CA of the multilayer body 2 and a second external electrode 3B provided on the second end surface CB of the multilayer body 2. When it is not particularly necessary to distinguish between the first external electrode 3A and the second external electrode 3B, they are collectively described as the external electrode 3. The external electrode 3 may cover not only the end surface C, but also a portion of each of the main surface A and the side surface B on the end surface C side.

### Short-Circuit Prevention Internal Electrode Layer 50

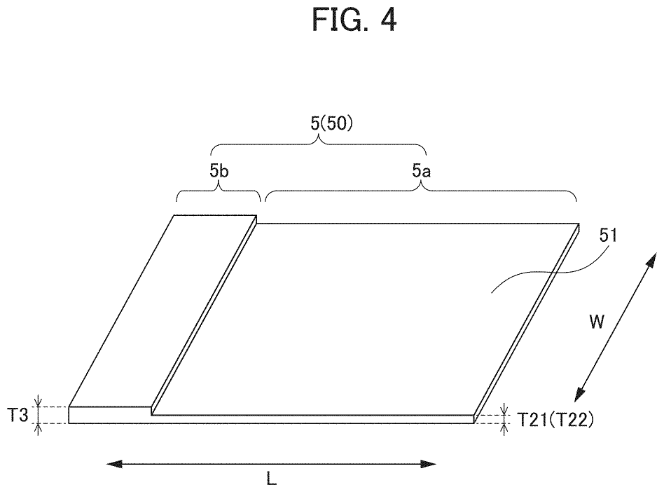

In a preferred embodiment of the present invention, the internal electrode layer 5 may include short-circuit prevention internal electrode layers in about 50% to about 80% of the total number of the internal electrode layer 5, for example. However, the short-circuit prevention internal electrode layer 50 may be provided on the entire internal electrode layer 5. FIGS. 4, 5, and 6 show preferred embodiments of short-circuit prevention internal electrode layers 50. The short-circuit prevention internal electrode layer 50 defines and functions as the internal electrode layer 5 including the thin portion 51. The thin portion 51 may have a thickness T21 at the opposing portion 5a. The thickness T21 may be no more than about 1/20 the thickness T1 of the dielectric layer 4, for example. The thin portion 51 may have a thickness T21 of about 0.005 μm or more and about 0.02 μm or less, for example. The thin portion 51 may be provided in the opposing portion 5a, and may not be provided in the extension portion 5b. This is because when the thin portion 51 is provided in the extension portion 5b, the response may deteriorate.

Furthermore, the thickness T3 of the thick portion may refer to the thickness of the internal electrode layer 5 other than the short-circuit prevention internal electrode layer 50 and the thickness of the portion of the short-circuit prevention internal electrode layer 50 other than the thin portion 51. The thickness T3 of the thick portion may be about 0.1 μm or more and about 0.4 μm or less, for example.

The short-circuit prevention internal electrode layer 50 of the first preferred embodiment of the present invention shown in FIG. 4 may include a thin portion 51 having a thickness T21 in the entire region of the opposing portion 5a. That is, the average thickness T22 of the opposing portion 5a and the thickness T21 of the thin portion 51 may be equal to each other, and may be about 0.005 μm or more and about 0.02 μm or less, for example.

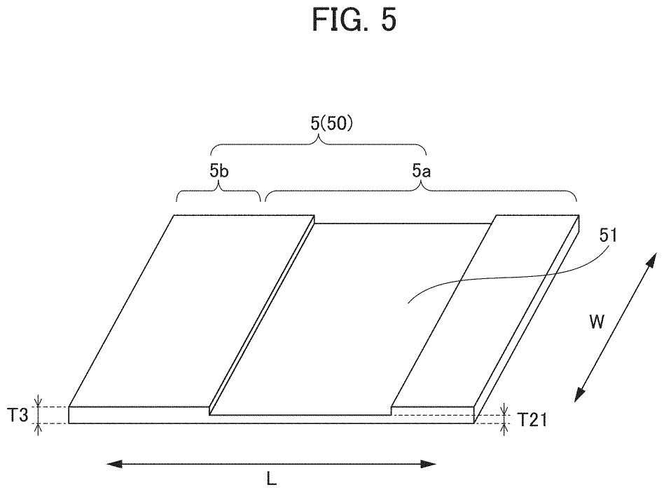

The short-circuit prevention internal electrode layer 50 of the second preferred embodiment of the present invention shown in FIG. 5 may have the thin portion 51 with the thickness T21 extending between both ends in the width direction W in a range of a predetermined length in the length direction L of the opposing portion 5a. Here, the thin portion 51 may exist over the entire surface of the internal electrode layer 5. However, since the surface coverage of the internal electrode layer 5 decreases and the capacitance decreases, the thickness of the thin portion 51 may be preferably about 9/10 or less the surface of the internal electrode layer 5, for example.

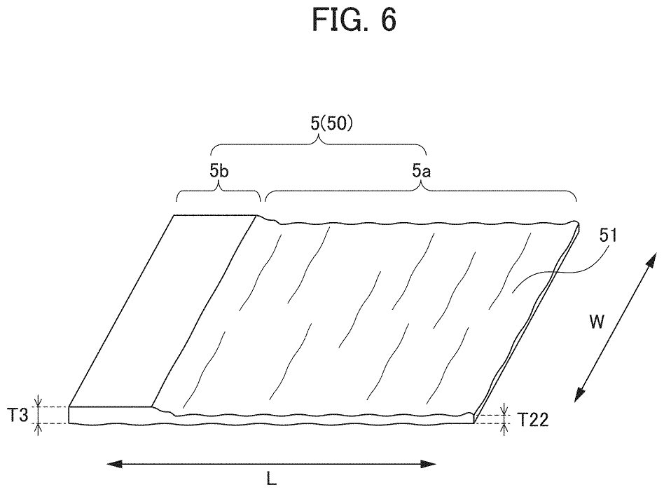

In the short-circuit prevention internal electrode layer 50 of the third preferred embodiment of the present invention shown in FIG. 6, the opposing portion 5a may have a thickness with some variation. The short-circuit prevention internal electrode layer 50 may include a portion other than the thin portion 51 having the thickness T21 at the opposing portion 5a. The average thickness T22 of the opposing portion 5a may be about no more than about 1/20 the thickness T1 of the dielectric layer 4, for example.

### Method of Measuring Thickness

The thickness T1 of the dielectric layer 4, the thickness T21 of the thin portion 51 of the short-circuit prevention internal electrode layer 50, the average thickness T22 of the opposing portion 5a, and the thickness T3 of the thick portion other than the thin portion 51 of the internal electrode layer 5 may be measured by the following method.

First, the periphery of the multilayer ceramic capacitor 1 may be fixed with a resin. Next, the LT cross-section extending in the length direction L and the lamination direction T of the multilayer ceramic capacitor 1 may be polished by a polishing machine. Then, polishing may be completed at a depth of about ½ in the width direction W of the multilayer ceramic capacitor 1, for example. This may expose the LT cross-section. Next, the thickness T1 of the dielectric layer 4, the thickness T21 of the thin portion 51 of the short-circuit preventing internal electrode layer 50, and the thickness T3 of the thick portion other than the thin portion 51 of the internal electrode layer 5 may be measured based on an image of a scanning electron microscope (SEM). The average thickness T22 of the opposing portion 5a may be obtained by measuring the thickness of the opposing portion 5a at a plurality of points, and calculating the average thereof.

### Method of Manufacturing Multilayer Ceramic Capacitor 1

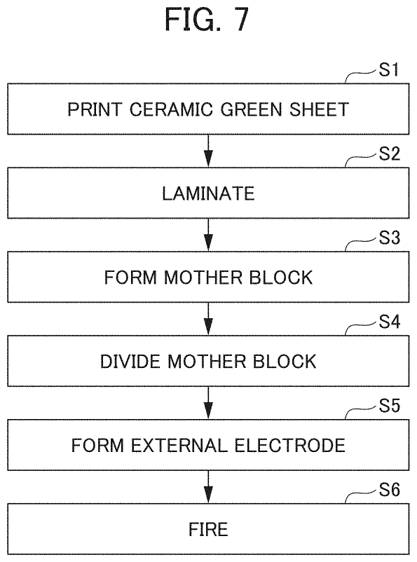

Next, a method of manufacturing the multilayer ceramic capacitor 1 will be described. FIG. 7 is a flowchart illustrating a method of manufacturing the multilayer ceramic capacitor 1.

### Ceramic Green Sheet Printing Step S1

In Step S1, a ceramic slurry including a ceramic powder, a binder, and a solvent may be coated on a carrier film in a sheet shape. At this time, the ceramic slurry may be applied so that the thickness T1 is about 0.3 μm or more and about 0.5 μm or less, for example, when finally provided as the dielectric layer 4 through sintering or the like.

Subsequently, an internal electrode layer paste including a metal powder, a binder, an additive such as a plasticizer and a dispersing agent, an organic solvent, and the like may be printed on the ceramic green sheet by screen printing, ink jet printing, gravure printing, or the like so as to have a strip-like pattern.

Here, the internal electrode layer paste printed on the sheet that defines and functions as the internal electrode layer 5 other than the short-circuit prevention internal electrode layer 50 may be printed at a thickness of about 0.3 μm or more and about 0.6 μm or less so that the thickness T3 of the thick portion may finally be about 0.1 μm or more and about 0.4 μm or less after sintering or the like, for example.

The internal electrode layer paste printed on the sheet defining and functioning as the short-circuit prevention internal electrode layer 50 may be printed with different thicknesses in a thick portion finally having a thickness T3 of about 0.1 μm or more and about 0.4 μm or less and a thin portion 51 finally having a thickness T21 of about 0.005 μm or more and about 0.02 μm or less, for example.

As an example, first, an internal electrode layer paste having a thickness obtained by subtracting a thickness corresponding to the thin portion 51 may be printed on a portion defining and functioning as the thick portion of the short-circuit prevention internal electrode layer 50. Next, an internal electrode layer paste having a thickness defining and functioning as the thin portion 51 may be printed on the entire sheet defining and functioning as the short-circuit prevention internal electrode layer 50. However, the present invention is not limited to this. The thin portion 51 and the thick portion may be printed separately.

Thus, a ceramic green sheet in which the internal electrode layer 5 is printed on the surface of the ceramic green sheet defining and functioning as the dielectric layer 4 is manufactured.

### Laminating Step S2

The plurality of ceramic green sheets may be laminated such that the internal electrode layer patterns are shifted by half pitch in the length direction L between the ceramic green sheets adjacent to each other in the lamination direction T. Furthermore, outer layer portion ceramic green sheets defining and functioning as the outer layer portions 7 may be laminated on both sides in the lamination direction T of the plurality of laminated ceramic green sheets.

### Mother Block Forming Step S3

Subsequently, the outer layer portion ceramic green sheets defining and functioning as the outer layer portions 7 may be laminated on both sides in the lamination direction T of the plurality of laminated ceramic green sheets, and a resulting product may be subjected to thermocompression bonding, such that the mother block may be formed.

### Mother Block Dividing Step S4

The mother block may then be divided to produce a plurality of multilayer bodies 2.

### External Electrode Forming Step S5

The external electrodes 3 may be formed at both ends of the multilayer body 2.

### Firing Step S6

Then, heat treatment may be performed in a nitrogen atmosphere for a predetermined time at a set firing temperature, and the external electrodes 3 may be each fired on the multilayer body 2, such that the multilayer ceramic capacitor 1 shown in FIG. 1 may be manufactured.

Here, the thickness of the internal electrode layer 5 may not be completely uniform. In the internal electrode layer 5, thin portions may be scattered unintentionally. In these thin portions, heat is likely to be generated because the resistance increases. When heat is generated, the internal electrode layer 5 may begin to melt from the thin portions, and may melt and extend toward the adjacent internal electrode layer 5.

At this time, when the thin portions each have a certain thickness although the thin portion is thinner than the other portions, the amount of the thin portion melted and extended toward the adjacent internal electrode layer 5 is not small, such that there is a possibility of the thin portion extending toward the other adjacent internal electrode layer 5 and causing short-circuit.

Furthermore, when the area of the thin portion is small, the melting spreads not only to the thin portion, but also to the thick portion around the thin portion, and the amount of melting and extending toward the adjacent internal electrode layer 5 increases, such that there is a possibility of extending toward the adjacent internal electrode layer 5 and causing short-circuit.

However, in a preferred embodiment of the present invention, the plurality of internal electrode layers 5 may include the short-circuit prevention internal electrode layer 50 including the thin portion 51 having the thickness T21 of no more than about 1/20 the thickness T1 of the dielectric layer 4 in the opposing portion 5a, for example.

Since the thin portion 51 provided in the short-circuit prevention internal electrode layer 50 may have the thickness T21 of no more than about 1/20 the thickness T1 of the dielectric layer 4, for example, even when heat is generated and melted, the amount of the thin portion 51 melted and extended toward the adjacent internal electrode layer 5 is small, such that the possibility of extending toward the adjacent internal electrode layer 5 and causing short-circuit is reduced.

Furthermore, in the multilayer ceramic capacitor 1 of the first preferred embodiment of the present invention, the entire region of the opposing portion 5a of the short-circuit prevention internal electrode layer 50 may be the thin portion 51, and the thickness T21 of the thin portion 51 may be no more than about 1/20 the thickness T1 of the dielectric layer 4, for example.

Therefore, even when thin spots of the thin portion 51 melt and spread to the periphery, the thin portion 51 is still thin as a whole, such that the amount of melting and extending toward the adjacent internal electrode layer 5 is small, and the possibility of extending toward the adjacent internal electrode layer 5 and causing short-circuit is reduced.

In the short-circuit prevention internal electrode layer 50 of the second preferred embodiment of the present invention, the thin portion 51 may extend in the width direction in the opposing portion 5a, and the thin portion 51 may have a length of about 1/10 or more the opposing portion 5a in the length direction L, for example.

Also in this case, since the thin portion 51 is provided in a region having a certain area, the thin portion 51 melts from thin spots and spreads to the periphery, and the amount of melting is small, such that the possibility of extending toward another adjacent internal electrode layer 5 and causing short-circuit is reduced.

In the short-circuit prevention internal electrode layer 50 of the third preferred embodiment of the present invention, the average thickness of the opposing portions 5a may be no more than about 1/20 the thickness T1 of the dielectric layer 4, for example.

Also in this case, even when the thin spots melt and spread toward the periphery in the thin portion 51, the thin portion 51 is still thin on average, and the amount of the thin portion melted and extended toward the other adjacent internal electrode layer 5 is small, such that the possibility of extending toward another adjacent internal electrode layer 5 is reduced.

### Test Result

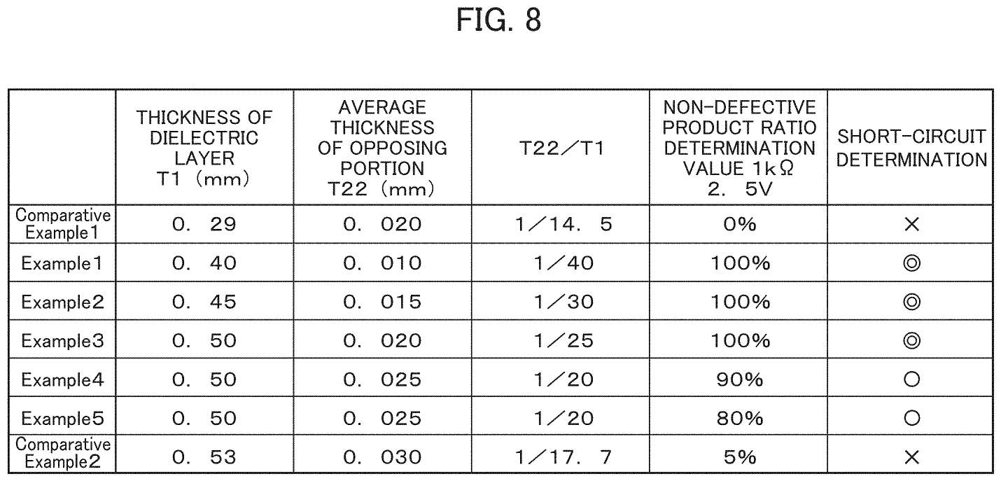

Next, test results of the advantageous effects of the multilayer ceramic capacitor 1 according to a preferred embodiment of the present invention will be described. FIG. 8 is a table showing test results of the advantageous effects of the multilayer ceramic capacitor 1 according to a preferred embodiment of the present invention.

In the first to fifth Examples, the multilayer ceramic capacitors 1 of the third preferred embodiment of the present invention were used in which the short-circuit prevention internal electrode layers 50 having the average thickness T22 which was no more than about 1/20 the thickness T1 of the dielectric layer 4 were included in the amount of about 70% of the internal electrode layer 5.

On the other hand, the multilayer ceramic capacitors 1 of the third preferred embodiment of the present invention were used in which the internal electrode layers having the average thickness T22 of the opposing portion 5a of 1/14.5 in Comparative Example 1, and the average thickness T22 of the opposing portion 5a of 1/17.7 in Comparative Example 2, both of which were larger than about 1/20 the thickness T1 of the dielectric layer 4, were included in the amount of about 70% of the internal electrode layer 5. In the Comparative Examples, the short-circuit prevention internal electrode layers 50 in which the average thickness T22 of the opposing portion 5a was no more than about 1/20 the thickness T1 of the dielectric layer 4 were not included.

### Non-Defective Product Ratio

The insulation resistance when a DC voltage of 2.5 V was applied between the first external electrode 3A and the second external electrode 3B of the multilayer ceramic capacitor 1 was measured. The number of measurements was 100. When a voltage of 2.5 V was applied, a multilayer ceramic capacitor having an insulation resistance of 1 kQ or more was counted as a non-defective product, and the percentage of non-defective products was defined as a non-defective product ratio.

### Short-Circuit Determination

In the short-circuit determination, when the non-defective product ratio was greater than 90%, it was determined to be ⊙ (bullseye symbol indicating excellent), when the non-defective product ratio was 80% or more and 90% or less, it was determined to be ∘ (circle symbol indicating satisfactory), and when the non-defective product ratio was 80% or less, it was determined to be X (cross symbol indicating poor).

As shown in FIG. 8, in Examples 1 to 5 in which the average thickness T22 of the opposing portion 5a was no more than 1/20 the thickness T1 of the dielectric layer 4, the short-circuit determination was “⊙” or “∘”, and the non-defective product ratio was 80% or more.

On the contrary, in the Comparative Example in which the average thickness T22 of the opposing portion 5a was smaller than 1/20 of the thickness T1 of the dielectric layer 4, the short-circuit determination was determined as X, and the non-defective product ratio was 0% or 5%.

As described above, it was verified that short circuit is unlikely to occur in the multilayer ceramic capacitor 1 according to a preferred embodiment of the present invention.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of internal electrode layers and a plurality of dielectric layers alternately laminated therein; and
external electrodes respectively provided on both end surfaces in a length direction intersecting a lamination direction in the multilayer body, and being electrically connected to the plurality of internal electrode layers; wherein
the plurality of internal electrode layers each include an opposing portion and an extension portion, the opposing portion of a first of the internal electrode layers being opposed to an opposing portion of a second of the internal electrode layers adjacent in the lamination direction, the extension portion extending from the opposing portion and being connected to one of the external electrodes in the length direction;
the dielectric layers each have a thickness T1 of about 0.3 μm or more and about 0.5 μm or less; and
the plurality of internal electrode layers include short-circuit prevention internal electrode layers, each including a thin portion having a thickness T21 which is no more than about 1/20 of the thickness T1 in each of the opposing portions.

2. The multilayer ceramic capacitor according to claim 1, wherein, in the short-circuit prevention internal electrode layers, an average thickness T22 of the opposing portions is no more than about 1/20 of the thickness T1.

3. The multilayer ceramic capacitor according to claim 1, wherein, in the short-circuit prevention internal electrode layers, an entire region of each of the opposing portions is the thin portion.

4. The multilayer ceramic capacitor according to claim 1, wherein, in the short-circuit prevention internal electrode layers, the thin portion extends in a width direction in each of the opposing portions.

5. The multilayer ceramic capacitor according to claim 4, wherein the thin portion extending in the width direction has a length of about 1/10 of a length in the length direction of each of the opposing portions.

6. The multilayer ceramic capacitor according to claim 1, wherein the short-circuit prevention internal electrode layers are provided in an amount of about 50% to about 80% of the plurality of internal electrode layers.

7. The multilayer ceramic capacitor according to claim 1, wherein the multilayer ceramic capacitor has a rectangular or substantially rectangular shape.

8. The multilayer ceramic capacitor according to claim 1, wherein each of the short-circuit prevention internal electrode layers is provided on an entirety of a respective one of the internal electrode layers.

9. The multilayer ceramic capacitor according to claim 1, wherein the thickness T21 is about 0.005 μm or more and about 0.02 μm or less.

10. The multilayer ceramic capacitor according to claim 1, wherein the thin portion is provided in the opposing portion and is not provided in the extension portion.

11. The multilayer ceramic capacitor according to claim 1, wherein the internal electrode layers that are not the short-circuit prevention internal electrode layers include a thick portion.

12. The multilayer ceramic capacitor according to claim 11, wherein the thick portion has a thickness of about 0.1 μm or more and about 0.4 μm or less.

13. The multilayer ceramic capacitor according to claim 1, wherein, in the short-circuit prevention internal electrode layers, an average thickness T22 of the opposing portions is equal to the thickness T21.

14. The multilayer ceramic capacitor according to claim 13, wherein each of the thickness T21 and the thickness T22 is about 0.005 μm or more and about 0.02 μm or less.

15. The multilayer ceramic capacitor according to claim 1, wherein the thin portion extends over an entirety of a surface of the internal electrode layer.

16. The multilayer ceramic capacitor according to claim 1, wherein the thickness T21 of the thin portion is about 9/10 or less of a surface of the internal electrode layer.

17. The multilayer ceramic capacitor according to claim 1, wherein the opposing portion has variations in thickness.
